(19) United States
(12) Patent Application Publication
(10) Pub. No.: US 2008/0001444 A1
(43) Pub. Date: Jan. 3, 2008

(54) Saddle Structure for a Bicycle

(76) Inventor: Feng-Jui WU, Jiali Township (TW)

Correspondence Address: Dr. BANGER SHIA, 102 Lindencrest Ct, Sugar Land, TX, 77479-5201, US

(21) Appl. No.: 11/426,975

(22) Filed: Jun. 28, 2006

(51) Int. Cl. B62J 1/00

(52) U.S. Cl. 297/195.1

(57) ABSTRACT

A saddle structure comprises: a saddle, a press device, a bulb, a photosensitive member, and a switch. When the rider sits on the saddle, the switch is switched on, and the saddle will be subject to the weight of the rider; meanwhile, the weight of the rider will act on the press device, so that the press device will produce electric power for feeding the bulb; at this moment, if the photosensitive member detects that the environment is dark, it will turns on the bulb. Since the bulb is disposed at the bottom of the press device, namely, the bottom of the saddle, it can illuminate a large area beneath the saddle, almost the whole body of the bicycle, thus ensuring a safe riding in a dark environment.

### BACKGROUND OF THE INVENTION

1. Field of the Invention

The present invention relates to a bicycle saddle, and more particularly to a bicycle saddle structure that is capable of producing light by itself.

2. Description of the Prior Art

FIG. 1 shows a conventional saddle structure for a bicycle, reference number 100 indicates a bicycle rear wheel, and 200 indicates the rear fender. A reflective sticker 300 is located at the lower portion of the rear fender 200 as a warning for drivers or pedestrians to keep at a safe distance.

FIG. 2 shows another conventional saddle structure for a bicycle, wherein a light 600 is installed at the lower portion of a rear fender 500 of the rear wheel 400, serving as a warning for drivers or pedestrians to keep at a safe distance.

The problem with reflective sticker 300 and the light 600 arises from the illumination area of the reflective sticker: the light is limited to the periphery of the body of the reflective sticker, and hence the light can't illuminate all area of the bicycle body. In other words, the bicycle is only visible from a very short distance: there could be not enough time for other drivers to dodge.

The present invention has arisen to mitigate and/or obviate the afore-described disadvantages.

### SUMMARY OF THE INVENTION

The primary objective of the present invention is to provide a bicycle saddle structure that is capable of producing light by itself.

A saddle structure for a bicycle in accordance with the present invention comprises: a saddle installed at a top center of a bicycle as a seat for the rider; a press device installed in the saddle, so that whenever the saddle is subject to a load, the load will be simultaneously transmitted to the press device, making the press device move up and down, and the upward and downward motion of the press device will produce electric power, which in turn feeds a bulb disposed at the bottom of the press device, namely, at the center of the bottom of the saddle, as an illuminating device for illuminating a body of the bicycle; a photosensitive member disposed at a front bottom of the saddle for controlling the on/off of the bulb by sensing the brightness of the environment; and a switch disposed inside the saddle for turning on/off a power source. Initially, the press device is installed in the saddle to produce electric power for the bulb by taking advantage of the upward and downward motion of the saddle. And the bulb is disposed at the bottom of the press device, namely, at the center of the bottom of the saddle, as an illuminating device for illuminating the body of the bicycle. Then, the photosensitive member is disposed at the front bottom of the saddle for controlling the on/off of the bulb by sensing the brightness of the environment. Finally, the switch is disposed inside the saddle 1 for turning on/off the power source; in use, the switch is switched on, when the rider sits on the saddle, the saddle will be subject to the weight of the rider. Meanwhile, the weight of the rider will act on the press device, so that the press device will produce electric power for feeding the bulb, at this moment, if the photosensitive member detects that the environment is dark, it will turns on the bulb. Since the bulb is disposed at the bottom of the press device, namely, the bottom of the saddle, it can illuminate a larger area beneath the saddle, almost the whole body of the bicycle, thus ensuring safe riding in a dark environment.

### BRIEF DESCRIPTION OF THE DRAWINGS

FIG. 1 is a cross sectional view of showing a conventional bicycle saddle;

FIG. 2 is a cross sectional view of showing another conventional bicycle saddle;

FIG. 3 is an exploded view of showing a saddle structure in accordance with a preferred embodiment of the present invention;

FIG. 4 is a perspective view of showing the saddle structure in accordance with the preferred embodiment of the present invention;

FIG. 5 is a cross sectional view of showing the saddle structure in accordance with the preferred embodiment of the present invention; and

FIG. 6 is a circuit diagram of the saddle structure in accordance with the preferred embodiment of the present invention.

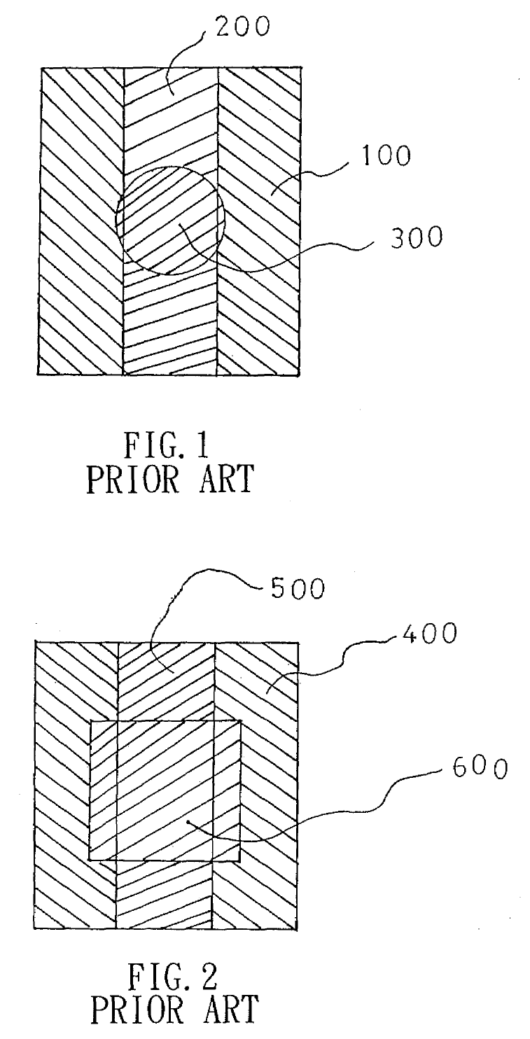

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

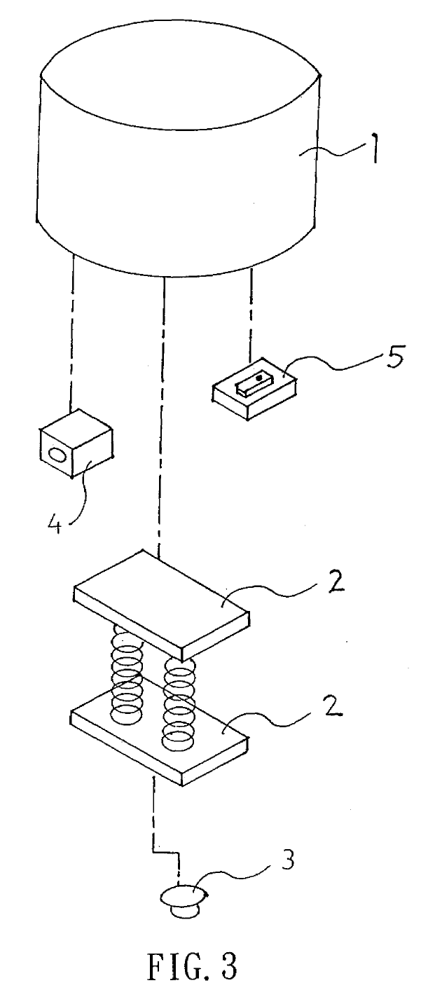

Referring to FIG. 3, which is an exploded view of showing a saddle structure in accordance with a preferred embodiment of the present invention. The saddle structure comprises: a saddle 1, a press device 2 a bulb 3, a photosensitive member 4, and a switch 5. The saddle 1 is installed at the top center of a bicycle as a seat for the rider. The press device 2 is installed in the saddle 1. When the saddle 1 is subjected to a load, the load will be simultaneously transmitted to the press device 2, making the press device 2 move up and down. The upward and downward motion of the press device 2 produces electric power, which in turn feeds the bulb 3. The bulb 3 is disposed at the bottom of the press device 2, namely, at the center of the bottom of the saddle 1, as an illuminating device for illuminating the body of the bicycle. The photosensitive member 4 is disposed at the front bottom of the saddle 1 for controlling the on/off of the bulb 3 by sensing the brightness of the environment. The switch 5 is disposed inside the saddle 1 for turning on/off the power source.

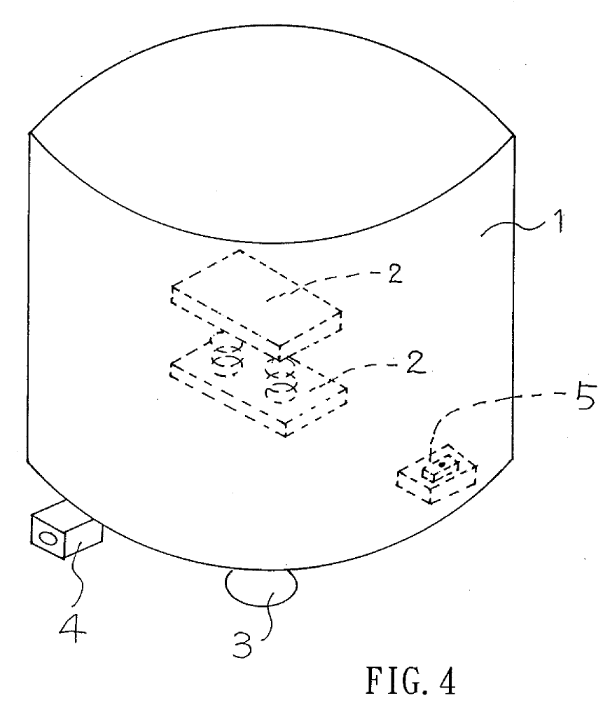

Referring to FIG. 4, initially, the press device 2 is installed in the saddle 1 to produce electric power for the bulb 3 by taking advantage of the upward and downward motion of the saddle 1. Then the bulb 3 is disposed at the bottom of the press device 2, namely, at the center of the bottom of the saddle 1, as an illuminating device for illuminating the body of the bicycle. And the photosensitive member 4 is disposed at the front bottom of the saddle 1 for controlling the on/off of the bulb 3 by sensing the brightness of the environment. Finally, the switch 5 is disposed inside the saddle 1 for turning on/off the power source.

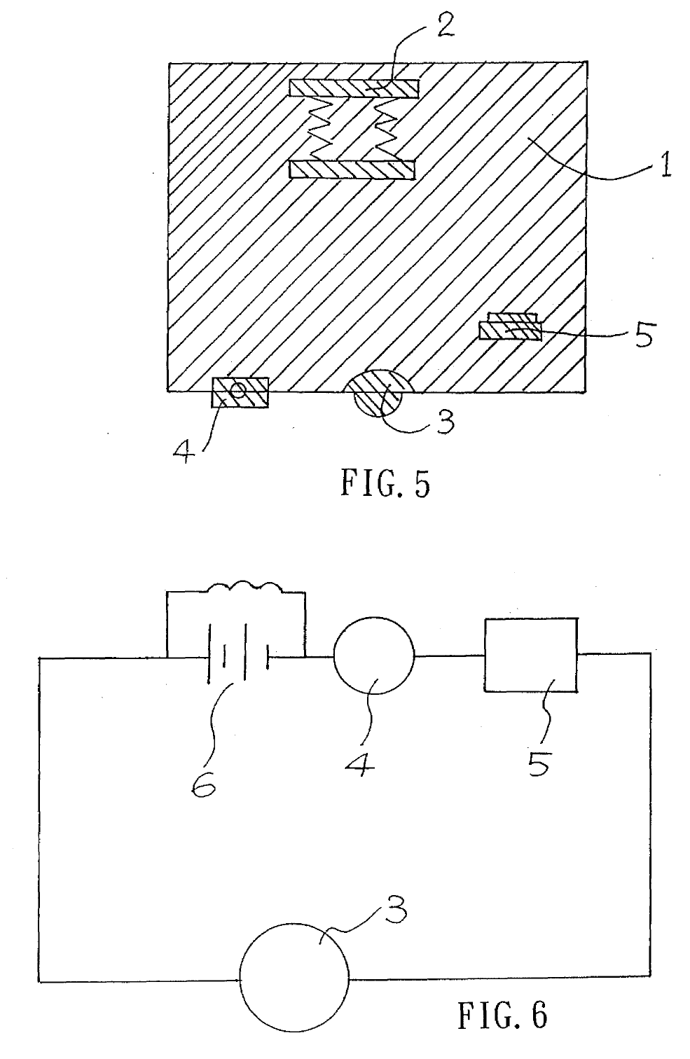

Referring to FIG. 5, the press device 2 is installed in the saddle 1 and serves to produce electric power for the bulb 3 by taking advantage of the upward and downward motion of the saddle 1. The bulb 3 is disposed at the bottom of the press device 2, namely, at the center of the bottom of the saddle 1, as an illuminating device for illuminating the body of the bicycle. The photosensitive member 4 is disposed at the front bottom of the saddle 1 for controlling the on/off of the bulb 3 by sensing the brightness of the environment. The switch 5 is disposed inside the saddle 1 for turning on/off the power source.

In use, the switch 5 is switched on. When the rider sits on the saddle 1, the saddle 1 is subject to the weight of the rider, and the weight of the rider will act on the press device 2, so that the press device 2 will produce electric power for feeding the bulb 3. At this moment, if the photosensitive member 4 detects that the environment is dark, it will turns on the bulb 3. Since the bulb 3 is disposed at the bottom of the press device 2, namely, the bottom of the saddle 1, it can illuminate a large area beneath the saddle 1, almost the whole body of the bicycle, ensuring safe riding in a dark environment.

FIG. 6 is a circuit diagram in accordance the preferred embodiment of the present invention. Both ends of the press device 2 are connected to both ends of a power source 6. One end of the power source 6 is connected to one end of the photosensitive member 4, and another end of the photosensitive member 4 is connected to an end of the switch 5. Another end of the switch 5 is connected to an end of the bulb 3, another end of the bulb 3 is connected to another end of the power source 6, thus forming a circuit diagram of the saddle.

It is learned from the above descriptions that the upward and downward motion of the press device produces electric power, the press device serves as a touch type push and press switch. When the rider sits on the saddle, the saddle will be subject to a downward force and produce electric power for feeding the bulb. And the photosensitive member will detect the brightness of the environment and then determine whether to turn on the bulb or not. Since the bulb is disposed at the bottom of the saddle, when it is on it illuminates a large area beneath the saddle, almost the whole body of the bicycle, improving the safe riding in a dark environment.

While we have shown and described various embodiments in accordance with the present invention, it is clear to those skilled in the art that further embodiments may be made without departing from the scope of the present invention.

What is claimed is:

1. A saddle structure for a bicycle comprising:
a saddle installed at a top center of a bicycle as a seat for the rider;
a press device installed in the saddle, when the saddle is subjected to a load, the load will be simultaneously transmitted to the press device, making the press device move up and down, the upward and downward motion of the press device will produce electric power, which in turn feeds a bulb;
the bulb disposed at the bottom of the press device, namely, at the center of the bottom of the saddle, as an illuminating device for illuminating a body of the bicycle;
a photosensitive member disposed at a front bottom of the saddle for controlling the on/off of the bulb by sensing the brightness of the environment; and
a switch disposed inside the saddle for turning on/off a power source;
wherein the press device is initially installed in the saddle and serves to produce electric power for the bulb by taking advantage of the upward and downward motion of the saddle, and then the bulb is disposed at the bottom of the press device, namely, at the center of the bottom of the saddle, as an illuminating device for illuminating the body of the bicycle, after that, the photosensitive member is disposed at the front bottom of the saddle for controlling the on/off of the bulb by sensing the brightness of the environment, and finally, the switch is disposed inside the saddle for turning on/off the power source, in use, the switch is switched on, when the rider sits on the saddle, the saddle will be subjected to the weight of the rider, and meanwhile the weight of the rider will act on the press device, so that the press device will produce electric power for feeding the bulb, at this moment, if the photosensitive member detects that the environment is dark, it will turns on the bulb, since the bulb is disposed at the bottom of the press device, namely, the bottom of the saddle, it can illuminate a large area beneath the saddle, almost the whole body of the bicycle, thus ensuring safe riding in a dark environment.
